(19) United States
(12) Patent Application Publication
(10) Pub. No.: US 2010/0162269 A1
(43) Pub. Date: Jun. 24, 2010

(54) CONTROLLABLE INTERACTION BETWEEN MULTIPLE EVENT MONITORING SUBSYSTEMS FOR COMPUTING ENVIRONMENTS

(75) Inventors: Gary J. Lucas, Pine Springs, MN (US); Paul S. Neuman, Shoreview, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 12/340,838

(22) Filed: Dec. 22, 2008

(51) Int. Cl. G06F 9/44

(52) U.S. Cl. 719/318

(57) ABSTRACT

An apparatus and method are provided for describing the interaction between event monitoring subsystems. A plurality of interactively-connected event monitoring subsystems in a computing system are configured. Events are collected by a first event monitoring subsystem of the plurality of event monitoring subsystems. Additional event information regarding one or more additional events are collected by the one or more second event monitoring systems. This additional information is received at the first event monitoring subsystem from one or more second event monitoring subsystems. An action is also triggered by the first event monitoring subsystem. The action is based on one or both of the collected performance events and the additional performance event information.

### FIELD OF THE INVENTION

The present invention is generally related to event monitoring within a computing system(s).

### BACKGROUND OF THE INVENTION

Ensuring proper operational performance and maintaining data integrity are essential to the efficacy of computing systems ranging from large-scale data processing systems to portable electronic devices. A transmission or storage error in even a single data bit can have a colossal impact on the intended use of the data or functionality of a computing system. Data corruption can be caused by any number of different factors associated with or otherwise influencing the data transaction, such as component or media failures, transmission line effects, electrical noise, poor connections, and the like.

To minimize the undesired consequences of data corruption, various manners of monitoring for data errors and ensuring data integrity have been implemented. Data errors can be detected using parity techniques. For example, parity errors can be identified using a parity bit to represent the odd or even values of 1's and 0's in data. A parity bit may be set to a certain state in each transmitted data block, depending on whether even or odd parity is used, and depending on the state of the bits in the data block. When the transmitted data (and parity bit) is received at a receiving device, it can check the parity to determine whether a data error has occurred. In some cases, a panty error represents a detectable condition in which an action can be taken to correct or otherwise account for the condition. For example, in some cases a parity error may be corrected, as in the case of Error Correction Code (ECC) methodologies. ECCs can be generated for a particular data block(s), and can be transmitted and/or stored with the data. Upon receipt or retrieval of the data block, the ECC code is regenerated using the same algorithm, and compared to the received or retrieved data to determine whether there is a disparity. If such a disparity exists, the data can in many cases be corrected, thereby obviating the need to retransmit the data or replace stored data.

In addition to data errors, computing systems can encounter computational errors such as counter overflow errors, counter underflow errors, stack overflow errors, etc. For example, counter overflow errors can occur as a result of insufficient memory or register capacity to store counter values. Arithmetic overflow conditions can occur where the result of an operation is larger than the storage or register capacity to store such a result. Such overflow errors may be unintentional, where their occurrences indicate error conditions. Alternatively, overflow errors may be expected possibility that may trigger an interrupt or other action. Arithmetic and/or counter underflow conditions may similarly occur.

Computer systems may also monitor system or component performance. For example, performance monitor events can be hardware detected conditions, conflicts, latencies, idle states, and other conditions that could affect the performance of the computing system.

Additional events that may be monitored and collected include interesting logical states, such as specific states of state machines, values of certain interface signals, and states of other internal control signals, all of which characterize the instantaneous operation of the computer system. These events are monitored and collected for the purpose of aiding the debugging of the computer system.

The management of such errors and events in a computing system is generally referred to herein as error handling. Error handling is an important aspect of computer system design. Large-scale computer systems typically have complex error handling systems to detect and deal with different types of errors and/or performance events that affect the operation and/or reveal the status of the system. Large-scale computing systems may require numerous error-handling subsystems to deal with different types of performance events and error conditions. These different subsystems all operate separately even though there might be similar actions taken on different subsystems.

It is desirable to simplify complexities of error handling systems, and reduce superfluous error handling resources. The present invention provides solutions to the aforementioned and other shortcomings of the prior art.

### SUMMARY

To overcome limitations in the prior art described above, and to overcome other limitations that will become apparent upon reading and understanding the present specification, the present invention discloses an apparatus and method for managing input/output transactions in data processing systems.

In accordance with one embodiment of the invention, a method is provided that comprises configuring a plurality of interactively connected event monitoring subsystems in a computing system. Events are collected by a first event monitoring subsystem of the plurality of event monitoring subsystems. The method also includes receiving, at the first event monitoring subsystem from one or more second event monitoring subsystems of the plurality of event monitoring subsystems, additional event information about one or more additional events collected by the one or more second event monitoring subsystems. At least one action can then be triggered by the first event monitoring subsystem based on one or both of the collected events and the additional event information.

According to a more particular embodiment of such a method, configuring the plurality of interactively connected event monitoring subsystems comprises one or both of configuring severity information associated with the events of the first event monitoring subsystem and configuring severity information associated with events collected by the one or more second event monitoring subsystems. In one embodiment the method further comprises programming the severity information via a user interface. A more particular embodiment further identifies the severity information as having a plurality of different severity levels, wherein particular severity levels are respectively associated with particular performance events. In a more particular embodiment the method further describes the action that can be taken as being a common action available from the plurality of actions for events of every severity level on at least one circuit of the plurality of circuits. In another particular embodiment of the invention the method further involves taking different actions for different severity levels of the event on at least one circuit of the plurality of circuits.

One embodiment of such a method includes describing the action as being one of a plurality of available actions and the action comprises sending the event to another subsystem for processing.

According to one embodiment, the method further comprises masking events wherein the masking comprises logically combining bits indicating the occurrence of a particular event with a mask register and storing results of the logical combination in an unmasked event register.

In accordance with another embodiment of the present invention, configuring the plurality of interactively connected event monitoring subsystems comprises programming the mask register via a user interface.

In another embodiment, triggering the action comprises triggering the action based on a logical combination of the event information and an action register. In another embodiment the triggered action comprises sending event information collected by one event monitoring subsystem to another event monitoring subsystem. When configuring the plurality of interactively connected event monitoring subsystems the action register may also be programmed using a user interface.

In another embodiment, the plurality of event monitoring subsystems comprises one or more of a performance monitor circuit, an error-capture circuit, a freeze circuit, and a debug circuit.

In yet another embodiment the events comprise one or more of an error event, a debug event, a performance monitor (PM) event and a network freeze event.

In accordance with another embodiment of the invention, an apparatus is provided that may include, for example, a plurality of interactively connected circuits. One or more event registers are also provided. The plurality of event registers are configured to capture information about circuit events of a first circuit of the plurality of circuits. A receiver that is configured to receive, from one or more second circuits of the plurality of circuits, additional event information about events of the one or more second circuits is also included. The apparatus also includes circuitry that is configured to trigger an action based on one or both of the logical combination of the events and the additional event information.

According to a more particular embodiment, the plurality of circuits is connected in a point-to-point configuration. In another embodiment the plurality of circuits is connected in a ring configuration.

In yet another embodiment of the invention, the circuitry that is configured to trigger an action comprises circuitry to trigger the action based on a logical combination of the event information and an action register. The circuitry configured to trigger an action may also comprise circuitry for sending event information collected by one event monitoring subsystem to another event monitoring subsystem.

In accordance with another embodiment of the invention an apparatus is provided. The apparatus includes means for configuring a plurality of interactively connected event monitoring subsystems in a computing system and means for collecting events by a first event monitoring subsystem of the plurality of event monitoring subsystems. The apparatus also includes means for receiving, at the first event monitoring subsystem from one or more second event monitoring subsystems of the plurality of event monitoring subsystems, additional event information about one or more additional events collected by the one or more second event monitoring subsystems as well as means for triggering, by the first event monitoring subsystem, at least one action based on one or both of the collected events and the additional event information.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram depicting some representative components of a generalized computing system and illustrating multiple event monitoring subsystems that are interactively connected in accordance with embodiments of the invention;

FIG. 2 is a flow diagram conceptually illustrating an interaction process involving first and second performance monitoring subsystems in accordance with embodiments of the invention;

FIG. 3 shows exemplary event monitoring circuits interconnected in accordance with embodiments of the invention;

FIG. 4 illustrates a more detailed view of an event monitoring subsystem including circuitry configured to detect and collect lower-level events in accordance with embodiments of the invention;

FIG. 5 illustrates an event monitoring subsystem that incorporates a maintenance interface that facilitates programming various registers of the event monitoring subsystem in accordance with embodiments of the invention;

FIG. 6 illustrates an exemplary circuit for one of the plurality of event monitoring circuits; and

FIG. 7 is a flow diagram illustrating a representative interaction process involving a plurality of performance monitoring subsystems in accordance with embodiments of the invention.

### DETAILED DESCRIPTION OF THE ILLUSTRATED EMBODIMENTS

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Computing systems may have one or more event monitoring subsystems that track the status of various events occurring during operation of the system. For example, the subsystems may track events related to error detection and collection, debug event conditions, system performance monitoring, and/or other performance related events. In typical computer systems, all of the event monitoring subsystems operate independently of one another. This lack of interactivity between event monitoring subsystems limits the usefulness and debug capability of these event subsystems as a whole because information collected from one subsystem is not used by another subsystem. Although computer systems can include multiple event monitoring subsystems that redundantly monitor the same events, this approach is less desirable because of the additional circuitry required, adding to the expense and complexity of the overall system. It would be very beneficial to have the multiple event monitoring subsystems be able to interact with one another so that, for example, events collected by one subsystem can trigger actions available on other subsystems.

Embodiments of the present invention provide systems and methods that allow communication between the event monitoring subsystems. The subsystems are capable of interacting with each other so that one or more events from one of the event monitoring subsystems can trigger one or more available actions from another event monitoring subsystem(s). This interconnectivity of the event monitoring subsystems also requires less logic than previous non-interactive approaches, as interactivity eliminates the need for circuitry in multiple event monitoring subsystems to monitor the same events.

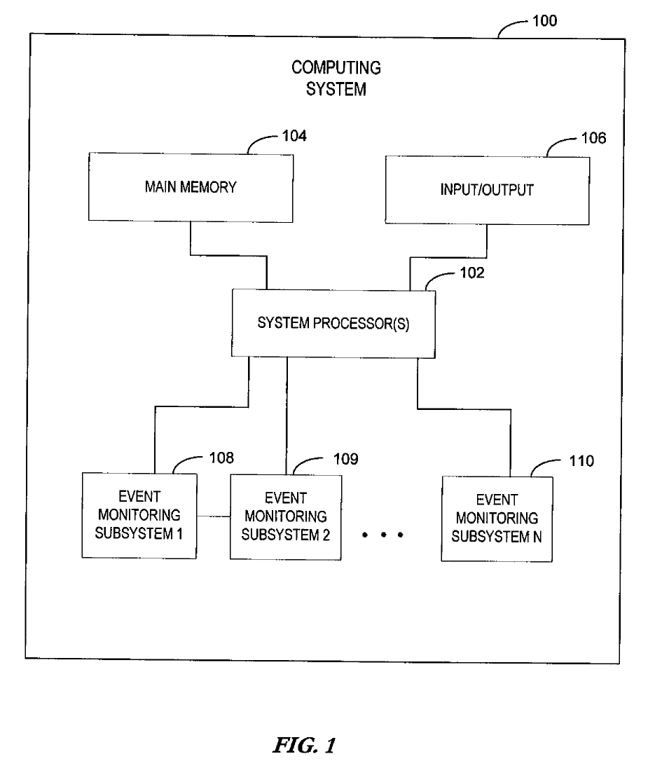

FIG. 1 is a block diagram of a generalized computing system 100 in which various embodiments of the invention may be practiced. FIG. 1 depicts one or more processors 102, main memory 104, input/output 106 and N event monitoring subsystems 108-110. Within this general computing environment, approaches of the invention advantageously allow communication between event monitoring circuit 1 and event monitoring circuit 2, for example. Each of the event monitoring subsystems 108-110 includes circuitry configured to monitor various events related to computer operation. For example, one of the event monitoring subsystems 108-110 may be a performance monitor circuit, another of the event monitoring subsystems 108-110 may be a freeze circuit, yet another of the event monitoring subsystems 108-110 may be an error detection and collection circuit, or a debug event circuit, or another type of event monitoring circuit.

Event data may be “collected” by a detection of a change in state of one or more bits indicating that the event has occurred. The bits representing the event collected by an event monitoring subsystem 108-110 may be passed directly to one or more other event monitoring subsystems 108-110. Alternatively or additionally, the bit(s) representing the event may be masked, combined with severity level information, and/or otherwise processed to produce event-related information which is passed between the event monitoring subsystems 108-110.

The event monitoring subsystems 108-110 may be interconnected in any arrangement. In the arrangement illustrated in FIG. 1, information related to events collected by one event monitoring subsystem 108-110 may be passed to any of the other event monitoring subsystems 108-110.

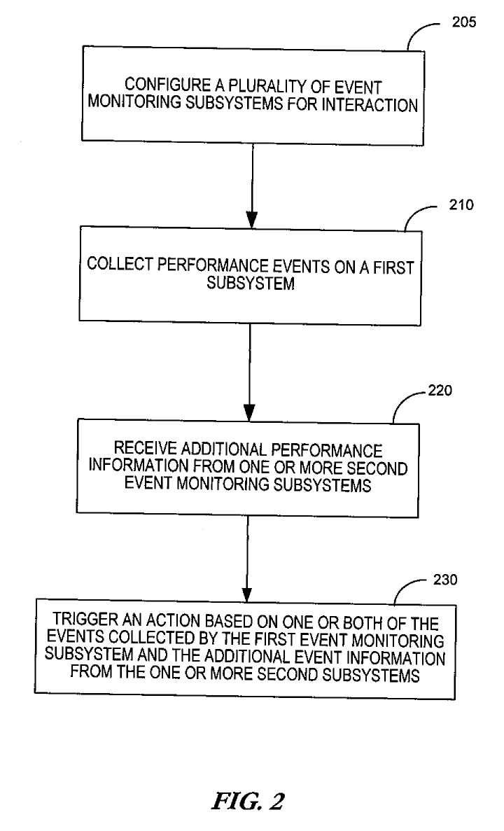

FIG. 2 is an exemplary flow diagram in accordance with the present invention illustrating one representative method for sharing event information between multiple different event monitoring subsystems. In the illustrated embodiment, a plurality of event monitoring subsystems are configured 205 for interaction. For example, the event monitoring subsystems may include one or more performance event monitoring subsystems such as error checking subsystems, debug subsystems, system performance monitoring subsystems and the like. Performance events are collected 210 by a first subsystem. The event monitoring subsystems may be configured via a user interface by programming various registers of the event monitoring subsystem.

Additional event monitoring subsystems of the plurality of subsystems also collect at least one event occurring within their domain. The subsystems may further process the collected event such as by masking the event bit(s) indicating the occurrence of the event and/or by logically combining the event bit(s) with other information such as a severity level assigned to the event. In some embodiments, the event mask and severity level associated with certain events may be programmably assigned during the configuration process.

Selected ones of the events collected by the additional monitoring subsystems and/or information derived from the collected events (e.g., logical combination of the event bit(s) with severity level) may be transferred between event monitoring subsystems. The additional event information is received 220 at the first subsystem from one or more second subsystems.

The first event monitoring subsystem may use both the event(s) it collects as well as the additional event information passed to the first subsystem from one more additional subsystems. An action is triggered 230 based on one or both of the events collected by the first event monitoring subsystem and the additional event information transferred from the one or more second subsystems.

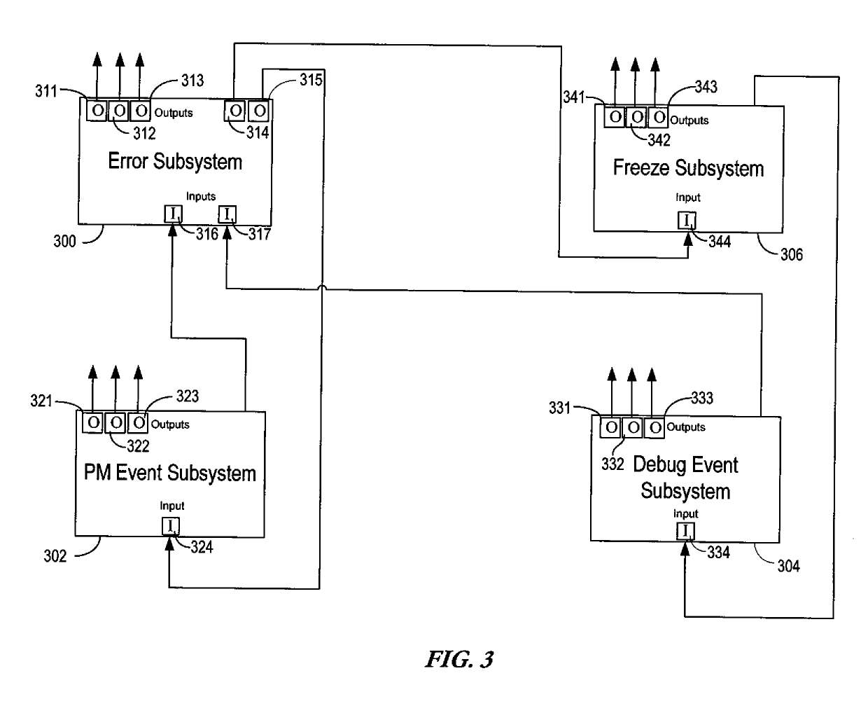

Turning now to FIG. 3, an example of multiple interactively connected performance event monitoring subsystems is provided. The plurality of performance event monitoring subsystems may include, for example, an error subsystem 300, a performance monitor (PM) subsystem 302, a freeze subsystem 306, and a debug network 304.

In the embodiment illustrated in FIG. 3, each subsystem 300, 302, 304, 306 is configured to collect events occurring within its domain. The subsystems 300, 302, 304, 306 are interconnected so that each subsystem 300, 302, 304, 306 receives event information from at least one other subsystem 300, 302, 304, 306. In this arrangement, the error subsystem 300 receives event information via input 317 from the debug event subsystem 304 and receives event information via input 316 from the PM event subsystem 302; the PM event subsystem 302 receives event information via input 324 from the Error subsystem 300; the freeze subsystem 306 receives event information via input 344 from the error subsystem 300; and the debug event subsystem 304 receives event information via input 334 from the Freeze subsystem 306.

The subsystems 300, 302, 304, 306 can trigger actions based on one or more of the collected events within its own subsystem domain and the event information received from one or more other subsystems 300, 302, 304, 306. FIG. 3 illustrates output signals 311-313, 321-323, 331-333, and 341-343 which are respectively produced by the subsystems 300, 302, 304, 306 as a result of triggering an action by the subsystems 300, 302, 304, 306. These outputs trigger specific actions appropriate for the corresponding subsystem.

For example, consider the error subsystem 300. The error subsystem 300 monitors for errors that occur within the domain of the error subsystem 300. Errors may be collected in the error subsystem 300 by changing the state of one or more bits in an error register of the error subsystem 300 when the errors occur.

In some embodiments, the error subsystem 300 can detect, store and trigger an action for one or more hardware detect errors such as parity errors, Error Correction Code (ECC) errors, counter overflow errors, counter underflow errors, etc. In some embodiments these errors are all OR'ed together to form one error signal. In other embodiments the errors may be assigned a severity level that corresponds to the type of error detected. The severity information associated with each error can determine how to handle the error or if the error can be ignored.

In some embodiments of the invention certain types of errors or specific errors can have disables so that not every error is reported if that is not the desired result.

In the example illustrated in FIG. 3, the error subsystem includes two inputs 316, 317 and three outputs 311-313. The inputs 316, 317 of the error subsystem 300 include event information sent from the PM event subsystem 302 and event information sent from the Debug event subsystem 304. The outputs 311-313 of the error subsystem 300 provide independently selectable error subsystem output actions. For example, the outputs may include an Activate Service Request Pin (SRQ) to a Service Processor, cause software (Bios) interrupt, and slam stop (stop the ASIC clocks). The additional outputs 314 and 315 can be enabled to send event information to Freeze subsystem, and send event information to performance monitor (PM) network and/or other outputs.

The PM event subsystem 302 includes one or more inputs 324 from other subsystems and one or more outputs 321-323. In some embodiments, the PM event subsystem provides for collection of hardware detected conditions, such as other performance related signals, that may be of interest to a user who is trying to characterize the system logic. The PM event subsystem 302 may have independently selectable output actions such as Snap Performance Monitor (PM) Counters, Delayed ASIC freeze, ASIC freeze, Delayed ASIC history freeze, and ASIC history freeze via the normal PM Event subsystem outputs 321-323. In addition it includes outputs to “send PM event information to other subsystems.”

The Debug event subsystem 304 may be used to monitor and collect events to aid in the debugging of the computer system. This can include, for example, interesting logical states, such as specific states of state machines, values of certain interface signals, and states of other internal control signals, all of which characterize the instantaneous operation of the computer system. These events can be monitored and collected for the purpose of aiding the debugging of the computer system. The actions triggered by the debug event subsystem generally make it easier to capture information and state of the internal logic of the computer system at a specific time or during a specific event. These actions can include, for example, slam stop of the logic clocks, freeze of the system transactions, history stack freeze or delayed history stack freeze, and activation of dedicated ASIC output pins that would trigger external logic analyzers or other equipment.

The Freeze subsystem 306 may be used to collect and distribute hardware detected conditions that cause a logic freeze where all transactions are prevented from being transmitted or received. As previously discussed, the output actions of the freeze subsystem 306 may be independently controllable. An exemplary, non-limiting list of the output actions of the freeze subsystem include Activate Application-Specific Integrated Circuit (ASIC) freeze, Activate ASIC history freeze, Activate ASIC freeze output pin, and “to other subsystem.”

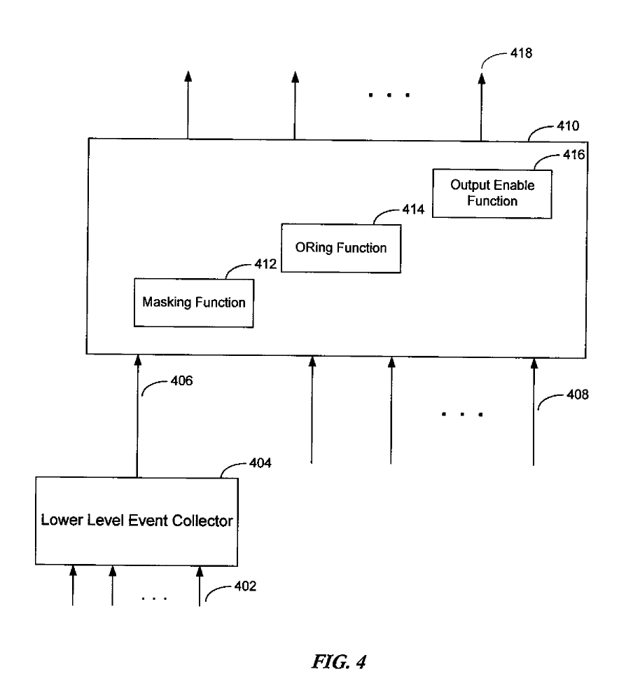

FIG. 4 illustrates a more detailed view of a generic event monitoring subsystem. The exemplary event subsystem illustrated in FIG. 4 includes circuitry 404 configured to detect and collect lower-level events. These lower level event inputs 402 may collect an event by changing in state one or more bits associated with a certain event input 402. The bit(s) associated with the collected events may be input into a top level event collector circuitry 410. The top level event collector 410 can also have as inputs additional event information 408 provided by other event monitoring subsystems (not shown). The top level event collector 410 may include a masking function 412 that uses mask registers to filter out events that are not important to look at or are undesirable to view at a given time. Unmasked events may then go through an OR'ing array 414 to create an event collection output that may include all of the events from all of the event collection circuits.

In some embodiments of the invention the top level event collector 410 includes severity level function. Severity registers of the severity level function store information regarding severity levels that are assigned to each event. Events may be combined together based on their common severity level, for example. The top level event collector 410 also includes an action enable function 416. The action enable function 416 may use action registers to allow selecting an action that can be common for all events or an action that can be selected based on the severity levels of the events, for example. An exemplary action provided by the action enable function 416 could be an enable to send to the next subsystem which would generate an output on the signal line interconnecting the subsystem to the next subsystem.

The mask registers, severity registers, and action registers described in connection with FIG. 4 may be user programmable through a maintenance interface. The programmability of these registers provides flexibility in determining which events are considered by the event monitoring subsystems, assigning severity levels to the events and determining actions corresponding to the events.

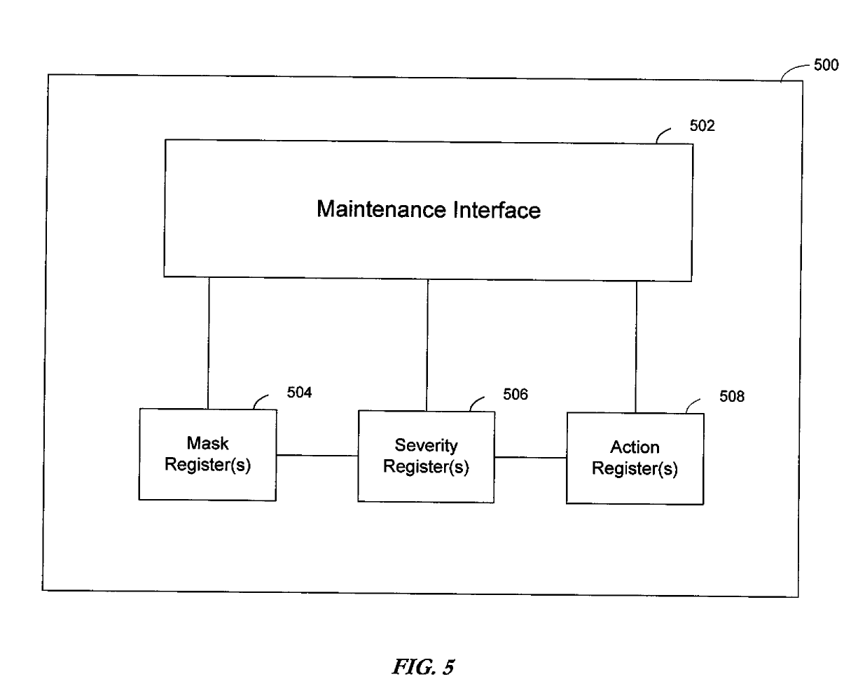

FIG. 5 illustrates an event monitoring subsystem 500 that incorporates a maintenance interface 502 that facilitates programming various registers 504, 506, 508 of the event monitoring subsystem 500. Programmability of one or more of the registers 504, 506, 508 according to this embodiment of the invention provides a system and method wherein event occurrences within the system are handled in a highly-flexible manner. That is, a user employs a maintenance interface 502 to program one or more of the mask register(s) 504, one or more of the severity level register(s) 506, and/or one or more of the action register(s) 508 within the subsystem 500. Any or all of the registers 504, 506, 508 in the subsystem 500 are readable and writable by a maintenance interface 502 which is accessible by a user. For example, the maintenance interface 502 may have access to a network via a Configuration and Status Register (CSR) ring of the type that is known in the art. Alternatively, some other type of maintenance interface (e.g., scan set) may be used for this purpose.

In accordance with one embodiment of the invention, events detected by any one of the plurality of event monitoring subsystems each have a corresponding severity level stored in the severity registers of the monitoring subsystems. In an exemplary subsystem the severity levels could be informational, passive, critical, fatal, for example. These severity levels may be programmed or otherwise configured to correspond to different types of events. For example, the different event collector circuits could be connected in a ring shape or alternatively in a point-to point fashion, in which the event collector subsystems are connected in a linear fashion. Knowing this, the engineer can program each of the registers to allow an event of a specific severity through until it reaches its desirable destination circuit where it can be handled or trigger an action.

The system allows an occurrence from one circuit (e.g., the Error subsystem circuit) to be handled according to an action selected for a different circuit, if desired. For instance, assume that one of the events that was originally considered merely informational within the error circuit is found during checkout to indicate a situation that should result in a freeze action. As an example, an engineer or other personnel can programmably enable this as described below.

First, the engineer enables detection of this event within the error circuit by programming the bit within the mask register 504 for this event to enable event detection. Then a severity level is selected for this event. It may be desirable to select a severity level for this event that will only be used for that particular event, and no other events within that network. The action register 508 for that severity level is then programmed to ensure that when the event is detected, the signal is forwarded to the adjacent circuit. If desired, additional actions may be enabled in the action register 508 as well.

Next, assume the circuits are interconnected in a ring, and the adjacent circuit happens to be the freeze circuit. This is the most-straightforward situation. The mask, severity level, and action registers of the freeze circuit can be set to ensure the detected error event that was propagated from the error circuit results in initiation of the desired action whenever that signal is activated within the error circuit.

The adjacent circuit may not be the freeze circuit. If this is the case, the various registers within the adjacent network must be programmed so that the detected event from the error circuit is again propagated to the next circuit in the ring, and so on, until that event is propagated to the desired destination circuit (in this example, the freeze network) so that the desired action may be initiated.

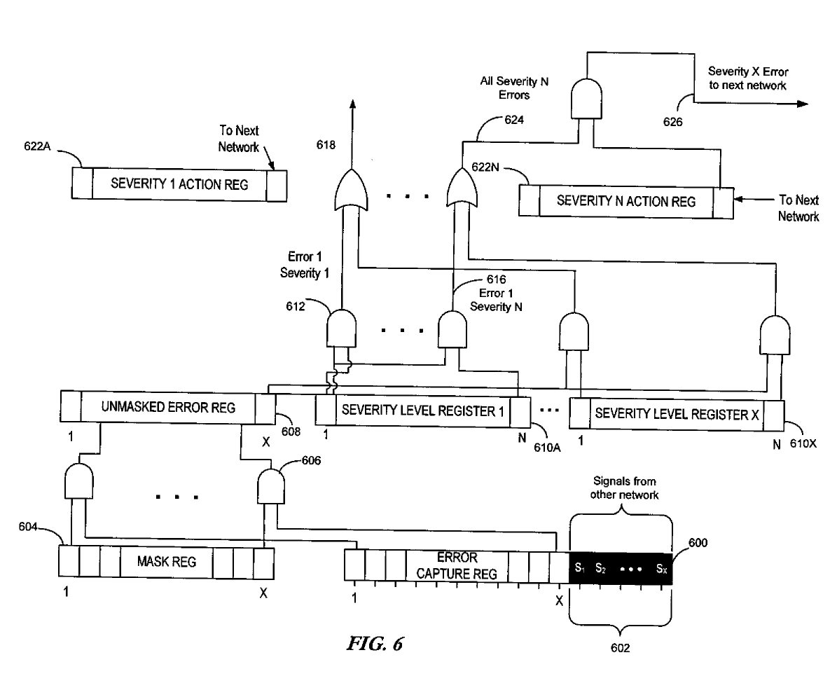

FIG. 6 illustrates a more detailed view of an exemplary subsystem diagram in accordance with the embodiments of the present invention. In addition to capturing various types of events, the event capture register 600 can also capture signals 602 from other event collecting subsystems. Each signal captured within register 600 includes a corresponding mask bit within mask register 604. When the corresponding bit is set to “0” and “AND'ed” by a corresponding one of AND gates 606, the error signal is masked so that an error will not be detected. All unmasked errors (i.e., the ones for which detection is enabled) will be detected within register 608.

For each bit within register 608, a corresponding severity register is shown. Thus, if register 608 contains “X” bits, there will be X severity registers, shown as registers 610A-610X. Each severity register will include multiple bits. Each of these bits represents a corresponding severity level. For instance, there may be four bits, each corresponding to one of the following severity levels: informational, passive, critical, and fatal. Any number of severity levels may be defined for a given network, and all networks need not have the same number of severity levels. During use, a bit in each severity register is programmably set to select the severity level for the corresponding error. For instance, an engineer may programmably select error 1 to be “informational” by setting the bit corresponding to “informational” in the severity register that is provided for error 1. In a similar manner, a severity level is selected for each error type using a corresponding severity register. As described above, these registers may be programmed using a maintenance interface such as a CSR ring.

For each error, a corresponding signal is generated by a bank of AND gates 612 when an unmasked error signal is activated based on the selected severity level. For instance, assume that a severity level of 1 is selected for error 1. Error 1 is not masked via the corresponding bit in mask register 604. Therefore, when the error 1 signal is captured in the activated state in register 602, it is also captured in the activated state in unmasked error register 608, and results in the generation of an activated signal on line 614, which corresponds with Error 1/Severity 1. The other signals for error 1 (e.g., signal 616 corresponding to Error 1/SeverityN) will not be activated because that severity level is not selected for error 1. Next, all error signals for a given severity level are OR'ed together. For example, all error signals for severity level 1 are OR'ed to generate a Severity1_Error signal on line 618, and so on. Thus, if N severity levels exist, N such error signals will be generated.

For each Severity X_Error signal, a corresponding action register is provided. This is a master-bitted register with one bit for each action that is to be taken upon detection of the error signal of that severity level. In one embodiment, the possible actions are the same for all severity levels in a given network, but are not necessarily the same between networks. In another embodiment, it would be possible to have different actions for different severity levels of the same network, as well as having different actions between the networks. One of the possible actions is “enable for sending to next network”. This allows an error of the corresponding severity level to be provided to the “next” network for processing, when the networks are connected in a ring configuration. Thus, for example, when the “enable for sending to next network” bit 620 is activated for severity X action register 622 and the “all severity X errors” signal 624 is activated, the signal 626 will likewise be activated. This can be provided to the next network, which may be the debug network, for instance. Thus, for example, bits 602 that are captured within error capture register 600 are the various severity 1—severity X bits that are captured from an adjacent network.

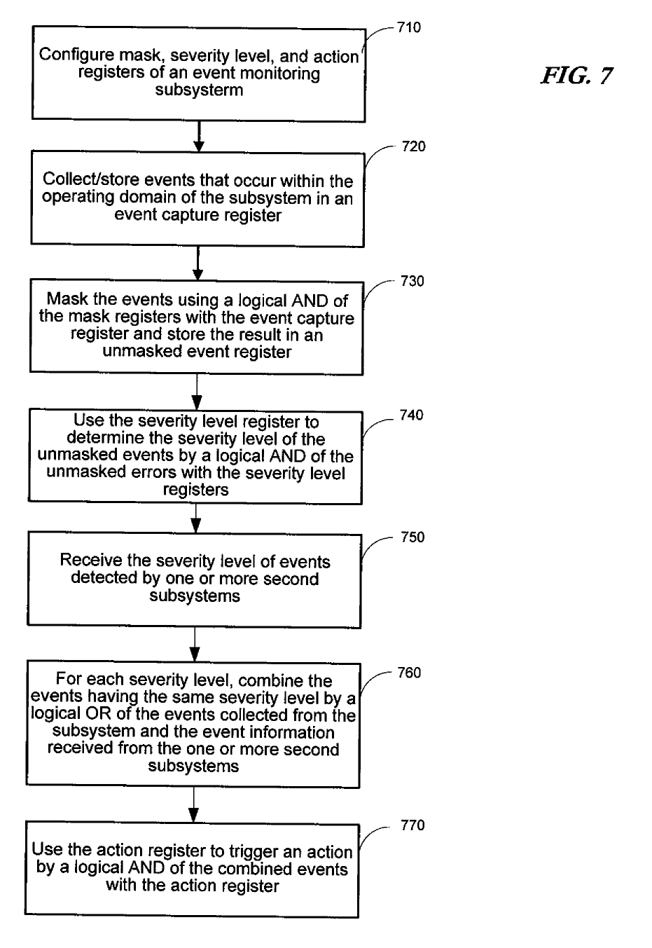

FIG. 7 is a flow graph illustrating a method of providing controllable interaction between event monitoring subsystems in accordance with some embodiments of the invention. Any number of event monitoring subsystems may be used and the event monitoring subsystems may be arranged in any configuration. For example, in one embodiment, the event monitoring subsystems are arranged in a ring configuration so that an event monitoring subsystem only receives information from a previous event monitoring subsystem in the ring. In another embodiment, the event monitoring subsystems are arranged so that each subsystem can receive an input from every other subsystem.

Initially one or more mask registers, severity registers, and action registers of the event monitoring subsystems are configured 710. In some embodiments, configuration of these registers is static; however, in other embodiments one or more of the registers may be programmable through a maintenance interface. Events that occur within the operating domain of the subsystem are then collected 720 in an event capture register.

The collected events may then be masked 730. This can be done by using a logical AND of the mask registers with the event capture register. The results are then stored in an unmasked event register. This can be done to leave out errors that are not of interest, for example. A severity level register is then used 740 to determine the severity level of the unmasked events by using a logical AND of the unmasked errors with the severity level registers. Each event can then be associated with a severity level.

The event monitoring subsystem may then receive 750 severity level events that were detected by one or more second subsystems. For each severity level, the additional severity level event information from one or more second subsystems are then combined 760 using a logical OR with the events collected from the subsystem. Finally, the action register is used 770 to trigger an action based on the logical combination of the event information from the subsystem and the event information from one or more other subsystems with the action register.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
configuring a plurality of interactively connected event monitoring subsystems in a computing system;
collecting events by a first event monitoring subsystem of the plurality of event monitoring subsystems;
receiving, at the first event monitoring subsystem from one or more second event monitoring subsystems of the plurality of event monitoring subsystems, additional event information about one or more additional events collected by the one or more second event monitoring subsystems; and
triggering, by the first event monitoring subsystem, at least one action based on one or both of the collected events and the additional event information.

2. The method of claim 1, wherein configuring the plurality of interactively connected event monitoring subsystems comprises one or both of configuring severity information associated with the events of the first event monitoring subsystem and configuring severity information associated with events collected by the one or more second event monitoring subsystems.

3. The method of claim 2, wherein configuring the plurality of interactively connected event monitoring subsystems comprises programming the severity information via a user interface.

4. The method of claim 3, wherein the severity information comprises a plurality of different severity levels, wherein particular severity levels are respectively associated with particular performance events.

5. The method of claim 4, wherein a common action is taken from the plurality of available actions for events of every severity level on at least one circuit of the plurality of circuits

6. The method of claim 4, wherein different actions are taken for different severity levels of the event on at least one circuit of the plurality of circuits.

7. The method of claim 1, wherein the action is one of a plurality of available actions and the action comprises sending the event to another subsystem for processing.

8. The method of claim 1, further comprising masking events, wherein the masking comprises logically combining bits indicating occurrence of a particular event with a mask register and storing results of the logical combination in an unmasked event register.

9. The method of claim 1, wherein configuring the plurality of interactively connected event monitoring subsystems comprises programming the mask register via a user interface.

10. The method of claim 1, wherein triggering the action comprises triggering the action based on a logical combination of the event information and an action register.

11. The method of claim 10, wherein the triggered action comprises sending event information collected by one event monitoring subsystem to another event monitoring subsystem.

12. The method of claim 10, wherein configuring the plurality of interactively connected event monitoring subsystems comprises programming the action register using a user interface.

13. The method of claim 1, wherein the plurality of event monitoring subsystems comprises one or more of a performance monitor circuit, an error-capture circuit, a freeze circuit, and a debug circuit.

14. The method of claim 1, wherein the events comprise one or more of an error event, a debug event, a performance monitor (PM) event and a network freeze event.

15. An apparatus, comprising:
a plurality of interactively connected circuits;
one or more event registers configured to capture information about circuit events of a first circuit of the plurality of circuits;
a receiver configured to receive, from one or more second circuits of the plurality of circuits, additional event information about events of the one or more second circuits; and
circuitry configured to trigger an action based on one or both of the logical combination of the events and the additional event information.

16. The apparatus of claim 15, wherein the plurality of circuits are connected in a ring configuration.

17. The apparatus of claim 15, wherein the plurality of circuits are connected in a point-to-point configuration.

18. The apparatus of claim 15 wherein circuitry configured to trigger an action comprises circuitry to trigger the action based on a logical combination of the event information and an action register.

19. The method of claim 18, wherein the circuitry configured to trigger an action comprises circuitry for sending event information collected by one event monitoring subsystem to another event monitoring subsystem.

20. An apparatus, comprising:
means for configuring a plurality of interactively connected event monitoring subsystems in a computing system;
means for collecting events by a first event monitoring subsystem of the plurality of event monitoring subsystems;
means for receiving, at the first event monitoring subsystem from one or more second event monitoring subsystems of the plurality of event monitoring subsystems, additional event information about one or more additional events collected by the one or more second event monitoring subsystems; and
means for triggering, by the first event monitoring subsystem, at least one action based on one or both of the collected events and the additional event information.
